(19) United States
(12) Patent Application Publication
(10) Pub. No.: US 2025/0039626 A1
(43) Pub. Date: Jan. 30, 2025

(54) METHOD AND SYSTEM FOR SIMULATING SPATIAL SOUND IN AUGMENTED REALITY AND COMPUTER-READABLE STORAGE MEDIUM

(71) Applicant: AMBIT MICROSYSTEMS (SHANGHAI) LTD., Shanghai (CN)

(72) Inventor: YU-HU YAN, New Taipei (TW)

(21) Appl. No.: 18/226,754

(22) Filed: Jul. 26, 2023

(51) Int. Cl. H04S 7/00

(52) U.S. Cl. CPC H04S 7/304; H04S 2400/11; H04S 2420/01

(57) ABSTRACT

A method for simulating spatial sound in augmented reality (AR) is disclosed. Multiple sound packets are emitted by a 4D object located on an anchor device in an AR scene. A distance, an angle and spatial relationship between the AR device and the anchor device are calculated. The sound packets are converted into 6DoF sound signals according to the calculated distance, the angle, the spatial relationship, an original sound source and user volume settings using a sound positioning algorithm. The 6DoF sound signals are sent to a playback device of the AR device.

### FIELD

The disclosure relates to augmented reality technology, in particular to a method and system for simulating spatial sound in augmented reality (AR).

### BACKGROUND

It is necessary to scan physical anchors to obtain the characteristics of the anchors to build the spatial model of the anchors. The virtual objects are bound with the anchors after the anchors are established. Thus, the virtual object can be fully presented in the augmented reality environment. However, there are many factors that cause errors when the physical anchors are scanned, such as angles, directions, light, surrounding environments, distances, and algorithms.

The above problems have been solved. However, in the prior art, only elative rotations between a head device and a source device can have the effect of a spatial sound source, that is, the spatial effect of 3 degrees of freedom (DOF). That is to say, the relationship between the head device and the source device is only the relative 3-axis relationship of fixed points, and there is no relative 3-axis relationship of moving points.

Thus, when the user approaches or moves away from the source device, there is no change relationship of the sound field, and only the relative rotation between the head device and the source device has the change relationship of the sound field.

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a system architecture diagram according to an embodiment of the disclosure;

FIG. 2 is a flowchart of method to establish anchor devices in an augmented reality environment according to an embodiment of the disclosure;

FIG. 3 is a diagram showing transmission of a spatial information packet according to an embodiment of the disclosure;

FIG. 4 is an application scenario diagram according to an embodiment of the disclosure;

FIG. 5 is a top view of an anchor device according to an embodiment of the disclosure;

FIG. 6 is a side view of an anchor device according to an embodiment of the disclosure;

FIG. 7 is a diagram of an augmented reality device according to an

embodiment of the disclosure;

FIG. 8 is a flowchart of an embodiment of a method for simulating spatial sound in augmented reality (AR) according to an embodiment of the disclosure;

FIG. 9 is a diagram of a first embodiment of an application example of simulated spatial sound effects according to an embodiment of the disclosure; and

FIG. 10 is a diagram of a second embodiment of an application example of simulated spatial sound effects according to an embodiment of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

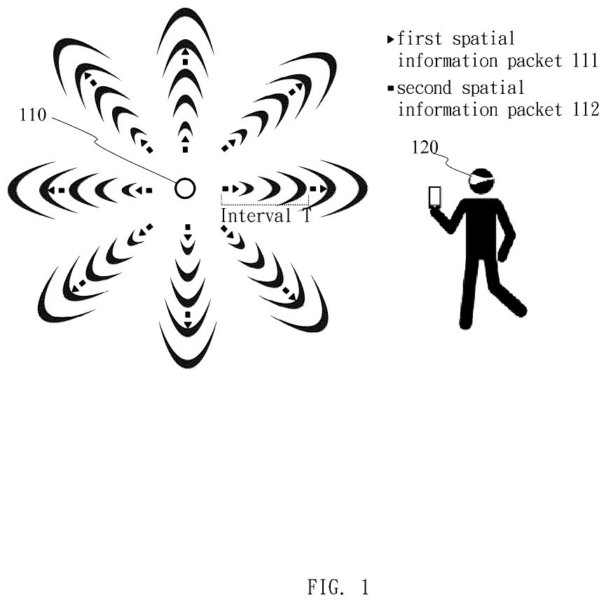

FIG. 1 is a system block diagram of a system according to an embodiment of the disclosure. The system is used for establishing an anchor in augmented reality (AR) environment includes an anchor device 110 and an AR device 120. As shown in FIG. 1, the anchor device 110 transmits a first spatial information packet 111 and a second spatial information device 112 at time interval T. The anchor device 110 further comprises transmitters (not shown in FIG. 1). The anchor device 110 can includes at least two transmitters for transmitting two kinds of communication technology. The anchor device 110 transmits the first spatial information packet 111 through a first communication technology and transmits the second spatial information packet 112 through the second communication technology. The first spatial information packet 111 and the second spatial information packet include an identification (ID) of the anchor device 110 and information as to angle of the transmitters in relation to the AR device 120. The first communication technology and the second communication technology comprise radio waves and ultrasonic, infrared, and laser transmissions.

In another embodiment, each of the transmitters includes two sub-transmitters. One of the sub-transmitters transmits the first spatial information packet through the first communication technology and the other one transmits the second spatial information packet through the second communication technology.

The AR device 120 receives the first spatial information packet 111 and the second spatial information packet 112. The AR device 120 comprises a processing unit (not shown in FIG. 1). The processing unit obtains a spatial relationship between the AR device 120 and the anchor device 110 according to the first spatial information packet 111 and the second spatial information packet 112. The spatial relationship includes an orientation, a horizontal distance, and a vertical height of the anchor device 110 relative to the AR device 120.

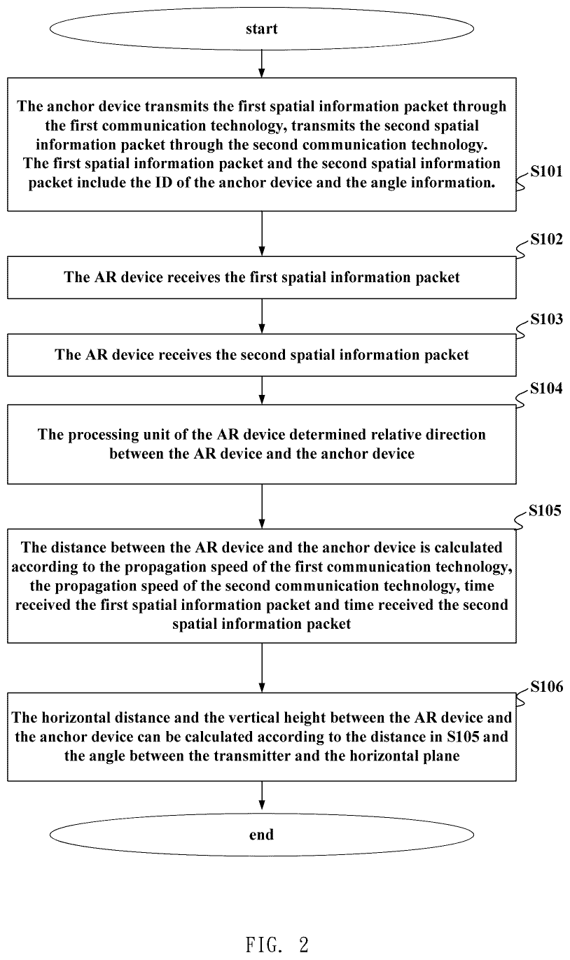

FIG. 2 is a flowchart of a method according to an embodiment of the disclosure.

As shown in FIG. 2, in step S101, the anchor device transmits the first spatial information packet through the first communication technology and transmits the second spatial information packet through the second communication technology. The first spatial information packet and the second spatial information packet include the ID of the anchor device and the angle information. The angle information comprises an orientation of the transmitter and an angle with reference to horizontal plane of the transmitter.

In step S102, the AR device receives the first spatial information packet from the anchor device through the first communication technology.

In step S103, the AR device receives the second spatial information packet from the anchor device through the second communication technology.

In step S104, the processing unit obtains the spatial relationship between the AR device and the anchor device according to the first spatial information packet and the second spatial information packet. The spatial relationship includes the orientation, the horizontal distance, and the vertical height between the two devices. The processing unit determines the location of the AR device relative to the anchor device according to orientation.

In step S105, the distance between the AR device and the anchor device is calculated by the AR device. A first propagation speed of the first communication technology and a second propagation speed of the second communication technology are known to the AR device. The distance between the AR device and the anchor device can be calculated according to the first propagation speed, the second propagation speed, time of the first spatial information packet be received, and time of the second spatial information packet be received. For example, the anchor device transmits the first spatial information packet through radio frequency (RF), and transmits the second spatial information packet through ultrasonic transmission. The first spatial information packet is received by the AR device at time T0. The second spatial information packet is received by the AR device at time T1. The propagation speed of RF (the first propagation speed) is approximately equal to the speed of light. The propagation speed of ultrasonic is slower, thus T1>T0. Time difference between receiving the first spatial information packet and the second spatial information packet is T1−T0. The distance between the AR device and the anchor device can be calculated according to the formula of distance=speed*time.

The first propagation speed of the first communication technology is known. The second propagation speed of the second communication technology is known. The distance between the AR device and the anchor device can be calculated according to the first propagation speed, the second propagation speed, and the time difference between receiving the first spatial information packet and the second spatial information packet.

In step S106, the horizontal distance and the vertical height between the AR device and the anchor device can be calculated by the AR device according to the distance in step S105 and the angle between the transmitter and the horizontal plane.

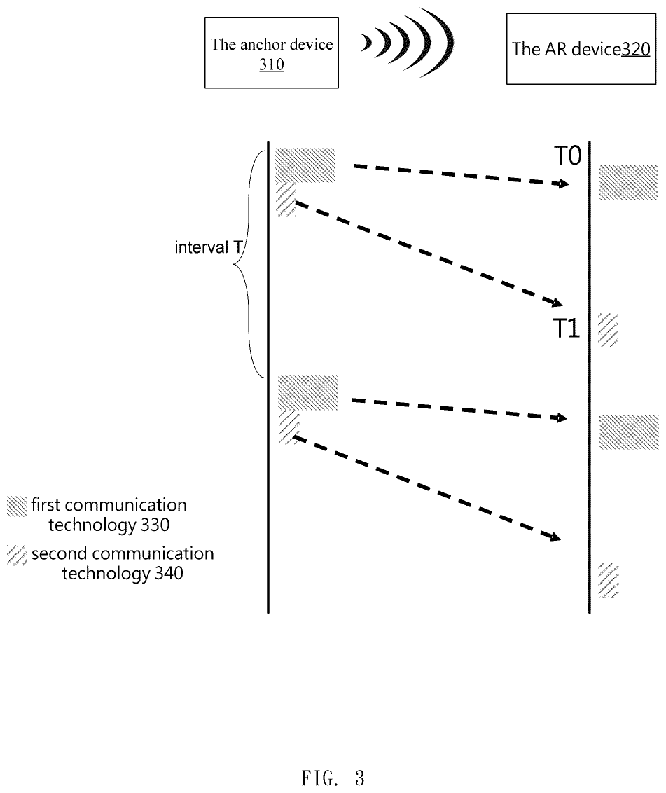

FIG. 3 is a diagram showing transmission of a spatial information packet according to an embodiment of the disclosure. As shown in FIG. 3, the anchor device 310 transmits the first spatial information packet through the first communication technology 330 and transmits the second spatial information packet through the second communication technology 340 every T time. In the embodiment, the first communication technology 330 is RF and the second communication technology 340 is ultrasonic beam, but transmission types are not limited to RF and ultrasonic. The propagation speed of RF is approximately equal to the speed of light 3×108 m/s, the propagation speed of ultrasonic in the air is 343 m/s. The AR device receives the first spatial information packet which is transmitted through RF at T0 and receives the second spatial information packet which is transmitted through ultrasonic at T1, therefore T1>T0. The distance between the AR device 302 and the anchor device 301 can be calculated according to the time difference T1−T0, the propagation speed of the first communication technology 330 and the propagation speed of the second communication technology 340.

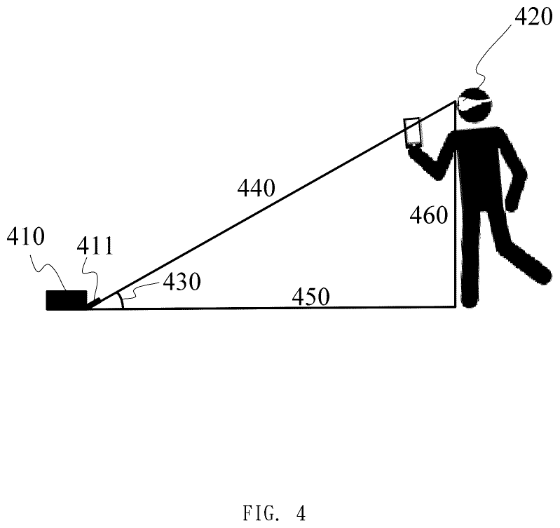

FIG. 4 is an application scenario diagram according to an embodiment of the disclosure. As shown in FIG. 4, the anchor device 410 is on the ground, the spatial information packets are transmitted through the first communication technology and the second communication technology by the transmitters. The transmitters are set to various angles. The AR device 420 receives the spatial information packet which is transmitted from the transmitter 411 when a user wearing the AR device 420 enters the application range of the anchor device 410. The angle 430 exists as an altitude angle between the horizontal plane and the transmitter 411. The anchor device 410 transmits spatial information packet with two kinds of communication technology at the same time. The spatial information packet includes the orientation of the transmitter 411 and the angle between the transmitter and the horizontal plane. The distance 440 between the anchor 410 and the AR device 420 can be calculated according to time difference between receipt of the transmissions through the first communication technology and the second communication technology, and thus the angle 430 between the horizontal plane and the transmitter 411. The horizontal distance 450 and the vertical height 460 between the anchor device 410 and the AR device 420 can be calculated according to the distance 440 and the angle 430. The spatial information packet includes the ID of the anchor device and the angle information. The AR device 420 can distinguish between the spatial information packet from individual anchor devices according to the ID of the anchor. The angle information includes the orientation of the transmitter 411 and the angle 430 between the transmitter and the horizontal plane.

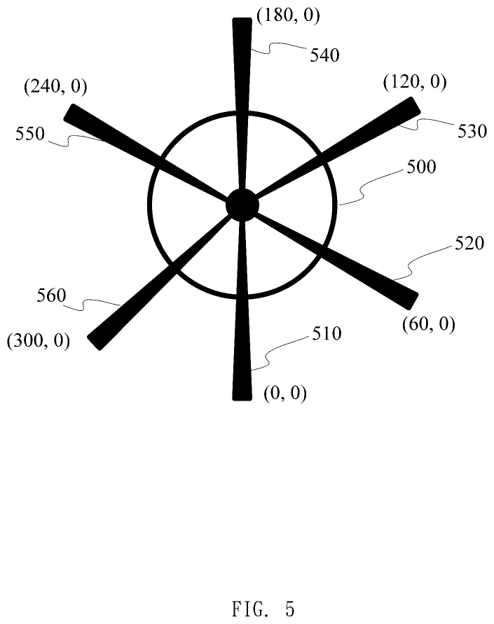

FIG. 5 is a top view of an anchor device according to an embodiment of the disclosure. As shown in FIG. 5, the anchor device 500 sets multiple transmitters with directional communication technology in different orientations. The AR device determines the relative position between the AR device and the anchor device 500 according to the orientation of the transmitter. The AR device receives the spatial information packet from a certain direction according to the characteristics of directional communication technology. As shown in FIG. 5, the AR device can only receive packets from a fourth transmitter 540 when the AR device is located at a 180-degree orientation relative to the anchor device. The spatial information packet of the fourth transmitter 540 includes information that the orientation is 180 degrees relative to the anchor device and that the angle between the transmitter and the horizontal plane is 0 degree. However, the directional communication technology is limited by the direction, and the range of the single transmitter is limited. Thus, the anchor device 500 needs multiple transmitters in order to cover all areas in the application space.

For example, as shown in FIG. 5, the effective range of each transmitter is 60 degrees. Users need to set at least six transmitters in different orientations to cover all application areas. A first transmitter 510 is set to the direction 0°, and the effective range is 330° to 30°. A second transmitter 520 is set to the direction 60°, and the effective range is 30° to 90°. A third transmitter 530 is set to the direction 120°, and the effective range is 90° to 150°. A fourth transmitter 540 is set to the direction 180°, and the effective range is 150° to 210°. A fifth transmitter 550 is set to the direction 240°, and the effective range is 210° to 270°. A sixth transmitter 560 is set to the direction 300°, and the effective range is 270° to 330°. The AR device can receive any spatial information packet which is transmitted from the anchor device, no matter where the AR device is located relative to the anchor device 500. The AR device can determine where the anchor device 500 is located according to the angle information in the spatial information packet.

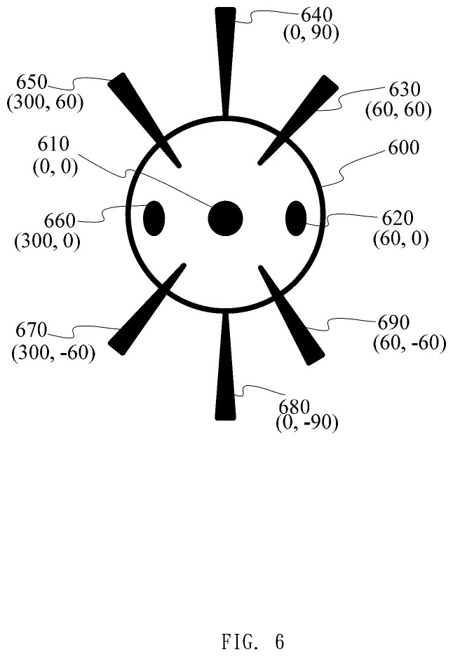

FIG. 6 is a side view of an anchor device according to an embodiment of the disclosure. In the different embodiment, the type of the anchor device 600 can be selected depending on the application environment. The anchor device 600 can be spherical or hemispherical but is not limited. For example, shape of the anchor device 600 is spherical. As shown in FIG. 6 the anchor device 600 sets multiple transmitters in different orientations. A first transmitter 610 is set to the direction 0° and the angle between the transmitter and the horizontal plane is 0°. A second transmitter 620 is set to the direction 60° and the angle between the transmitter and the horizontal plane is 0°. A third transmitter 630 is set to the direction 60° and the angle between the transmitter and the horizontal plane is 60°. A fourth transmitter 640 is set to the direction 0° and the angle between the transmitter and the horizontal plane is 90°. A fifth transmitter 650 is set to the direction 300° and the angle between the transmitter and the horizontal plane is 60°. A sixth transmitter 660 is set to the direction 300° and the angle between the transmitter and the horizontal plane is 60°. A seventh transmitter 670 is set to the direction 300° and the angle between the transmitter and the horizontal plane is −60°. An eighth transmitter 680 is set to the direction 0° and the angle between the transmitter and the horizontal plane is −90°. A ninth transmitter 690 is set to the direction 60° and the angle between the transmitter and the horizontal plane is −60°.

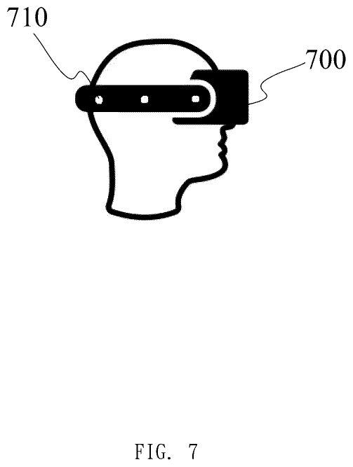

FIG. 7 is a diagram of an AR device according to an embodiment of the disclosure. As shown in FIG. 7, directional communication technology is used to identify the locational relationship between the anchor device and the AR device 700. Thus, there are multiple receivers set on the AR device 700. The white spots shown in FIG. 7 show the positions where multiple receivers may be set. However, the configuration in FIG. 7 is only to express that the AR device 700 needs to have receivers 710 in various positions. Thus, the AR device 700 can receive spatial information packet from various directions. The AR device can be any form of device such as head-mounted devices, smart glasses, smart phones, tablets, etc.

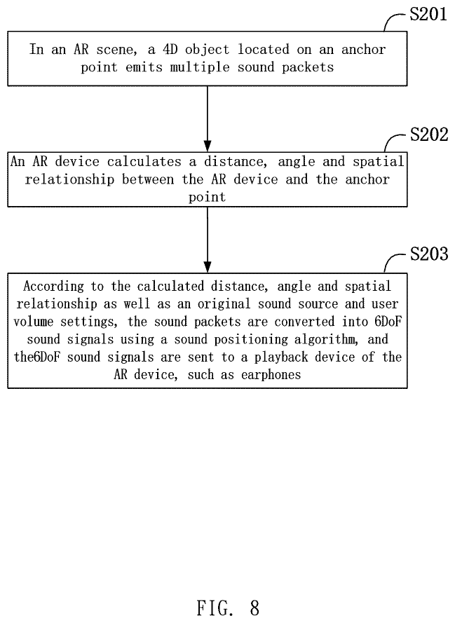

FIG. 8 is a flowchart of an embodiment of a method and system for simulating spatial sound in augmented reality (AR) according to an embodiment of the disclosure.

In step S201, in an AR scene, a 4D object located on an anchor point emits multiple sound packets.

In step S202, an AR device calculates a distance, an angle and spatial relationship between the AR device and the anchor point using the aforementioned algorithm.

In step S203, according to the calculated distance, angle and spatial relationship as well as an original sound source and user volume settings, the sound packets are converted into 6DoF sound signals using a sound positioning algorithm, for example, the head Related Transfer Functions (HRTF) which is also known as the anatomical transfer function (ATF), and the 6DoF sound signals are sent to a playback device of the AR device, such as earphones.

Referring to FIG. 1, an embodiment of a system for simulating spatial sound in augmented reality (AR) according to an embodiment of the disclosure comprises an anchor device 110 and the AR device 120. The anchor device 110 provides an AR object (not shown) which emits multiple sound packets in an AR scene. The AR device 120 calculates a distance, an angle and spatial relationship between the AR device 120 and the anchor device 110 using the aforementioned algorithm, and, according to the calculated distance, angle and spatial relationship as well as an original sound source and user volume settings, converts the sound packets into 6DoF sound signals using the HRTF which is also known as the ATF, and sends the 6DoF sound signals to a playback device of the AR device 120, such as earphones (not shown).

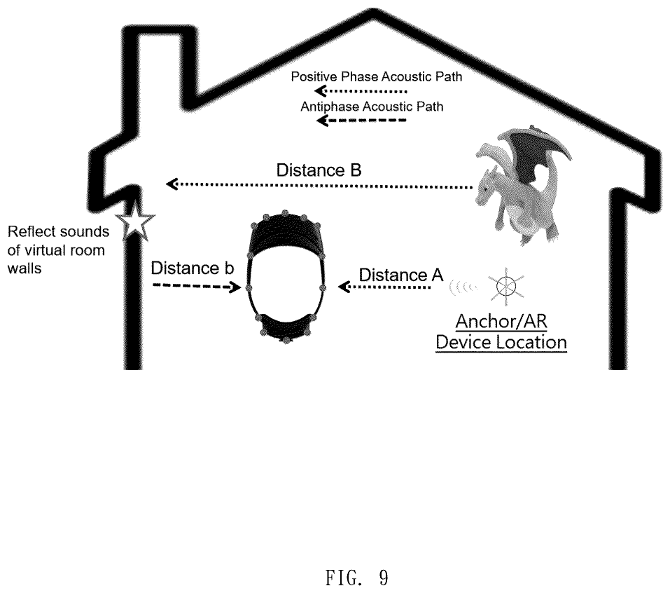

FIG. 9 is a diagram of a first embodiment of an application example of simulated spatial sound effects according to an embodiment of the disclosure.

The arrival time of the user's right-ear sound is equal to (“distance A”/343 m). The arrival time of the left-ear sound is equal to ((“distance b”+“distance B”)/343 m)*inverted waveform”. The sound level of the right ear is equal to “the sound pressure level”−20log* (“distance A”/“reference distance (user-defined)”). The volume of the left ear is equal to (“the volume of the right ear”−20log*(distance b+distance B)/“distance A”.

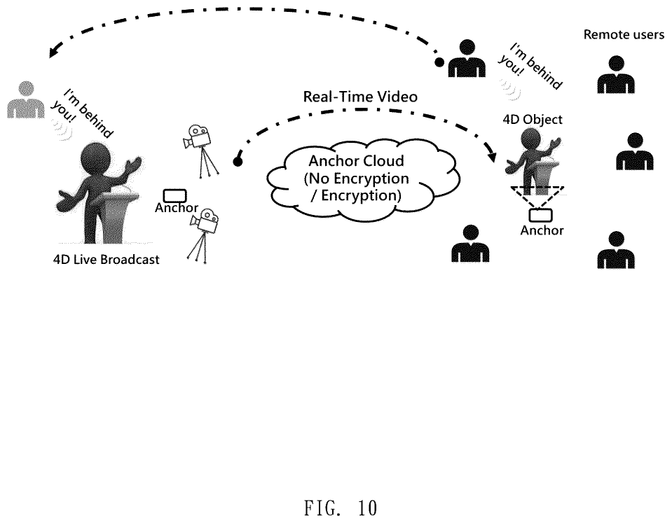

FIG. 10 is a diagram of a second embodiment of an application example of simulated spatial sound effects according to an embodiment of the disclosure.

The user's headband device can analyze the direction of the current anchor point, in the semi-virtual world (live broadcast or conference), and, therefore, corresponding spatial information is sent to a user at the other end, so that the headband device at the other end can render the corresponding space (video+audio). The speaker can also turn around and interact with the audience in this relative space (provided by the anchor point).

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method for simulating spatial sound in augmented reality (AR) executable by an AR device, comprising:
emitting multiple sound packets by a Four-dimensional (4D) object located on an anchor device in an AR scene;
calculating a distance, an angle, and spatial relationship between the AR device and the anchor device; and
converting the sound packets into 6 degrees of freedom (DoF) sound signals according to the calculated distance, the calculated angle, the calculated spatial relationship, an original sound source, and user volume settings using a sound positioning algorithm, and sending the 6DoF sound signals to a playback device of the AR device.

2. The method of claim 1, wherein the sound positioning algorithm is head Related Transfer Functions (HRTF).

3. A system for simulating spatial sound in augmented reality (AR), comprising:
an anchor device, configured to provide an AR object which emits multiple sound packets in an AR scene; and
an AR device, configured to calculate a distance, an angle, and spatial relationship between the AR device and the anchor device, convert the sound packets into 6 degrees of freedom (DoF) sound signals according to the calculated distance, the calculated angle, the calculated spatial relationship, an original sound source, and user volume settings using a sound positioning algorithm, and send the 6DoF sound signals to a playback device of the AR device.

4. The system for simulating spatial sound in AR of claim 3, wherein the sound positioning algorithm is head Related Transfer Functions (HRTF).

5. A non-transitory computer-readable storage medium storing game program which causes a computer to execute:
a process of emitting multiple sound packets by a Four-dimensional (4D) object located on an anchor device in an augmented reality (AR) scene;
a process of calculating a distance, an angle, and spatial relationship between the AR device and the anchor device; and
a process of converting the sound packets into 6 degrees of freedom (DoF) sound signals according to the calculated distance, the calculated angle, the calculated spatial relationship, an original sound source, and user volume settings using a sound positioning algorithm, and sending the 6DoF sound signals to a playback device of the AR device.
